(19) United States
(12) Patent Application Publication
(10) Pub. No.: US 2026/0228524 A1
(43) Pub. Date: Aug. 6, 2026

(54) TEXT GENERATION LEARNING METHOD, TEXT GENERATION METHOD, TEXT GENERATION LEARNING APPARATUS, TEXT GENERATION APPARATUS AND PROGRAM

(71) Applicant: NTT, Inc., Tokyo (JP)

(72) Inventors: Kosuke NISHIDA, Tokyo (JP); Kyosuke NISHIDA, Tokyo (JP); Itsumi SAITO, Tokyo (JP); Kuniko SAITO, Tokyo (JP)

(21) Appl. No.: 19/152,688

(22) PCT Filed: Feb. 6, 2023
(86) PCT No.: PCT/JP2023/003832

§ 371 Date: Jul. 31, 2025

(51) Int. Cl. G06N 3/08; G06F 40/10; G06N 3/0455

(52) U.S. Cl. CPC G06N 3/08; G06F 40/10; G06N 3/0455

(57) ABSTRACT

A computer performs an encoding step of receiving, as inputs, a source text and an instruction related to a summary of the source text, generating first features, which are a sequence of vectors for respective tokens constituting one of the instruction and the source text, and generating text features, which are a sequence of vectors for respective tokens of the instruction and the source text, based on another of the instruction and the source text and the first features, a decoding step of receiving the text features as an input and outputting probability distribution of a text, and a parameter update step of updating parameters of the encoding step and the decoding step based on a loss between the probability distribution and a text as a correct answer regarding the summary.

### TECHNICAL FIELD

The present invention relates to a text generation learning method, a text generation method, a text generation learning apparatus, a text generation apparatus, and a program.

### BACKGROUND ART

FLAN disclosed in Non-Patent Literature 1 is a language model capable of generating texts in accordance with instructions. FLAN can generate texts according to instructions in various tasks (Table 5 of Non-Patent Literature 1).

Since FAN is a language model generalized to all tasks, on the other hand, there is a large correlation between model size (Params) and performance (Norm. avg.) (Table 3 of Non-Patent Literature 1), and a large model is required to achieve high performance.

### CITATION LIST

### Non-Patent Literature

Non-Patent Literature 1: HyungWonChung, et al., “Scaling Instruction-Finetuned Language Models”, [online], Internet <URL:https://arxiv.org/pdf/2210.11416.pdf>

### SUMMARY OF INVENTION

### Technical Problem

Assuming use cases in individual companies, however, a T5-Large model (Table 5 of Non-Patent Literature 1) has a realistic level.

That is, roughly an 11B model is a limit of model size that can be operated by one latest GPU. Furthermore, considering a calculation cost for one query and a procurement cost of a latest GPU, it is desirable to operate at about 780M or 250M. Furthermore, a model of 62B or more needs a plurality of GPUS processing in synchronization, and there are high technical and cost barriers.

With such a model size, however, performance is significantly degraded (below a chance rate (performance of completely random, inaccurate prediction) in a case where Norm. Avg. is negative in Table 5 of Non-Patent Literature 1).

By specializing in a summarization task, therefore, it is necessary to suppress the model size to 1G or less and to learn a high-speed “model according to an instruction”.

Furthermore, in a case where summarization using an instruction is used as a service, typical ways of use are as follows.
Summarize a source text input by a user in accordance with a fixed instruction determined by the service.
The user inputs an instruction for a source text input thereby, and corrects the instruction several times while viewing results of summarization.

Even in the case of such usage, however, all instructions and source texts are encoded and decoded each time in the existing model. There is a problem, therefore, that extra calculation is performed and a calculation time increases.

The present invention has been made in view of the above points, and an object thereof is to provide improvement in calculation efficiency regarding summarization according to instructions.

### Solution to Problem

In order to solve the above problem, a computer performs an encoding step of receiving, as inputs, a source text and an instruction related to a summary of the source text, generating first features, which are a sequence of vectors for respective tokens constituting one of the instruction and the source text, and generating text features, which are a sequence of vectors for respective tokens of the instruction and the source text, based on another of the instruction and the source text and the first features, a decoding step of receiving the text features as an input and outputting probability distribution of a text, and a parameter update step of updating parameters of the encoding step and the decoding step based on a loss between the probability distribution and a text as a correct answer regarding the summary.

### Advantageous Effects of Invention

Calculation efficiency for summarization according to instructions can be improved.

### BRIEF DESCRIPTION OF DRAWINGS

FIG. 1 is a diagram illustrating a hardware configuration example of a text generation apparatus 10 according to an embodiment of the present invention.

FIG. 2 is a diagram illustrating a first functional configuration example at a time of learning by the text generation apparatus 10 according to the embodiment of the present invention.

FIG. 3 is a diagram illustrating an example of a self-attention matrix.

FIG. 4 is a flowchart for describing an example of a first processing procedure of a process for learning an encoding unit 11 and a decoding unit 12 according to a first embodiment.

FIG. 5 is a diagram illustrating a second functional configuration example at the time of learning by the text generation apparatus 10 according to the embodiment of the present invention.

FIG. 6 is a flowchart for describing an example of a second processing procedure of a process for learning the encoding unit 11 and the decoding unit 12 according to the first embodiment.

FIG. 7 is a diagram illustrating a functional configuration example of the text generation apparatus 10 at a time of inference according to the embodiment of the present invention.

FIG. 8 is a flowchart for describing an example of a processing procedure by the text generation apparatus 10 at the time of inference according to the first embodiment.

FIG. 9 is a flowchart for describing an example of a procedure for generating text features in a process for learning the encoding unit 11 and the decoding unit 12 according to a second embodiment.

FIG. 10 is a diagram illustrating an example of a self-attention matrix in generating instruction features in the second embodiment.

FIG. 11 is a diagram illustrating an example of a self-attention matrix in generating text features in the second embodiment.

FIG. 12 is a diagram illustrating an example of a self-attention matrix in a case where an instruction and a source text are simultaneously input at the time of learning according to the second embodiment.

FIG. 13 is a flowchart for describing an example of a processing procedure by the text generation apparatus 10 at the time of inference according to the second embodiment.

FIG. 14 is a flowchart for describing an example of a procedure for generating text features in a process for learning the encoding unit 11 and the decoding unit 12 according to a third embodiment.

FIG. 15 is a diagram illustrating an example of a self-attention matrix in generating source text features in the third embodiment.

FIG. 16 is a diagram illustrating an example of a self-attention matrix in generating text features in the third embodiment.

FIG. 17 is a diagram illustrating an example of a self-attention matrix in a case where an instruction and a source text are simultaneously input at the time of learning according to the third embodiment.

FIG. 18 is a flowchart for describing an example of a processing procedure by the text generation apparatus 10 at the time of inference according to the third embodiment.

### DESCRIPTION OF EMBODIMENTS

An embodiment of the present invention will be described hereinafter on the basis of the drawings. In the present embodiment, a text generation apparatus 10 that uses an instruction and a source text (text to be summarized) described in a natural language as inputs and that generates a summary sentence of the source text in accordance with the instruction (with the instruction as a constraint) will be described. Examples of the instruction include a query (a character string indicating a focus of the summary or the like) and order of keywords. The instruction is not limited to a focus or order, and any character string described in a natural language can be specified.

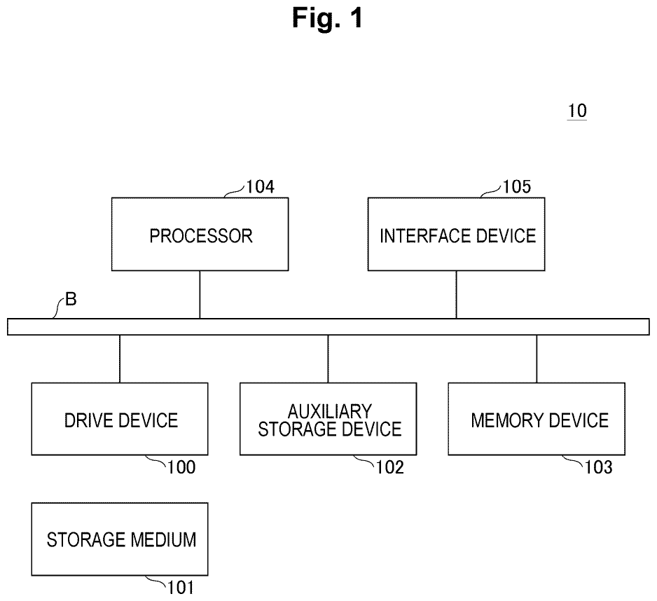

FIG. 1 is a diagram illustrating a hardware configuration example of the text generation apparatus 10 according to the embodiment of the present invention. The text generation apparatus 10 of FIG. 1 includes a drive device 100, an auxiliary storage device 102, a memory device 103, a processor 104, an interface device 105, and the like that are connected to one another via a bus B.

A program for achieving processing in the text generation apparatus 10 is provided by a storage medium 101 such as a CD-ROM. When the storage medium 101 storing the program is set in the drive device 100, the program is installed in the auxiliary storage device 102 from the storage medium 101 via the drive device 100. The program, however, need not necessarily be installed from the storage medium 101, and may be downloaded from another computer over a network, instead. The auxiliary storage device 102 stores the installed program, and also stores necessary files, data, and the like.

In a case where an instruction to start the program is given, the memory device 103 reads the program from the auxiliary storage device 102 and stores the program. The processor 104 is a CPU or a graphics processing unit (GPU), or a CPU and a GPU, and executes functions related to the text generation apparatus 10 in accordance with the program stored in the memory device 103. The interface device 105 is used as an interface for connecting to a network.

The processing performed by the text generation apparatus 10 is roughly divided into processing at a time of learning (training) for generating a summary sentence and processing at a time of inference. The processing at the time of learning and the processing at the time of inference will be sequentially described. Note that different computers may be used at the time of learning and at the time of inference.

### At Time of Learning

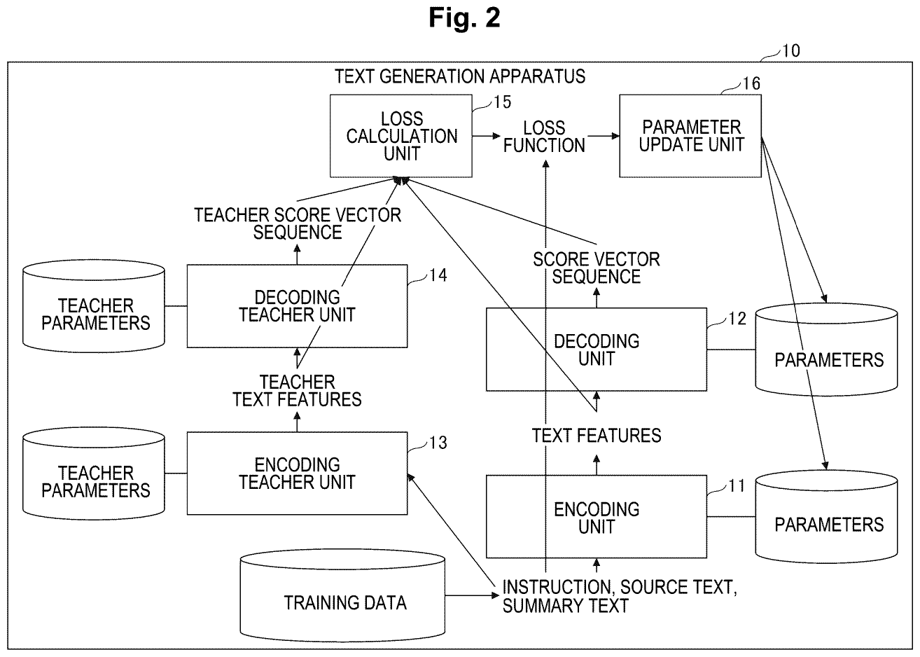

FIG. 2 is a diagram illustrating a first functional configuration example at the time of learning by the text generation apparatus 10 according to the embodiment of the present invention. In FIG. 2, an example of reducing model size by using a technique of knowledge distillation (Reference Literature 1) will be described. Literature information regarding each reference literature will be described later.

In FIG. 2, the text generation apparatus 10 includes an encoding unit 11, a decoding unit 12, an encoding teacher unit 13, a decoding teacher unit 14, a loss calculation unit 15, and a parameter update unit 16. Each of these units is achieved through processing performed by the processor 104 executing one or more programs installed in the text generation apparatus 10.

The encoding unit 11 is a neural network that receives texts (an instruction and a source text in the present embodiment) as inputs and that outputs text features. In the present embodiment, the encoding unit 11 employs an encoder structure (Reference Literature 1) using a transformer. Text features are a sequence of vectors for respective tokens constituting an input text (an instruction and a source text in the present embodiment). The sequence length of the sequence (token sequence), therefore, is equal to the number of tokens constituting the input text.

The transformer models an interaction between tokens in a self-attention layer (Reference Literature 2). Self-attention is usually expressed as a matrix (hereinafter referred to as a “self-attention matrix”).

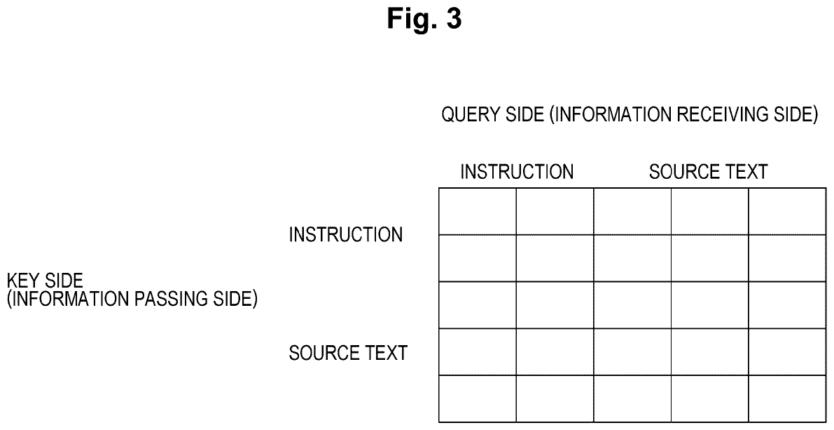

FIG. 3 is a diagram illustrating an example of the self-attention matrix. FIG. 3 illustrates a self-attention matrix in a case where the instruction includes two tokens and the source text includes three tokens. A token refers to one unit of text processing. For example, a word is an example of the token. The instruction and the source text are each represented as a token sequence.

Self-attention expresses degrees of relevance between all the tokens of the instruction and the source text (degrees of relevance between vectors corresponding to the respective tokens) as scores, and passes information regarding a certain token on a key side (vector corresponding to the token) to a certain token on a query side in accordance with the score.

The decoding unit 12 is a neural network that receives the text features generated by the encoding unit 11 as inputs and outputs a score vector sequence that is probability distribution of an output text (in the present embodiment, a text summarizing the source text). In a case where a probability of the t-th token being w is p(w, t), vocabulary size (the number of elements of a set of all tokens) is V, and length of the text is T, the score vector sequence P is T vectors in which V-dimensional vectors p(t) are arranged. In the present embodiment, the decoding unit 12 employs a decoder structure of a transformer (Reference Literature 1).

Note that the encoding unit 11 and the decoding unit 12 constitute a language model to be trained. Parameters (model parameters) of the encoding unit 11 and the decoding unit 12 are learning targets. The language model configured by the encoding unit 11 and the decoding unit 12 is a student model in knowledge distillation.

The encoding teacher unit 13 and the decoding teacher unit 14 constitute a language model as a teaching model in knowledge distillation. That is, the encoding teacher unit 13 is a teacher model of the encoding unit 11, and is a neural network that receives texts (an instruction and a source text in the present embodiment) as inputs and that outputs teacher text features. The decoding teacher unit 14 is a teacher model of the decoding unit 12, and is a neural network that receives the teacher text features generated by the encoding teacher unit 13 as inputs and that outputs a teacher score vector sequence that is probability distribution of a text. The teacher text features are data treated as correct answers to the text features. The teacher score vector sequence is data treated as correct answers to the score vector sequence.

In knowledge distillation, parameters of a student model are learned while parameters (teacher parameters) of the teacher model are fixed. At this time, learning is performed in such a way as to bring internal features and outputs of the student model closer to internal features and outputs of the teacher model.

Usually, a model larger than the student model or a model learned using an algorithm different from one used for the student model is used as the teacher model. Since the teacher model is unnecessary at the time of inference, a large model can be employed. For example, FLAN-Base of Non-Patent Literature 1 may be employed for the encoding unit 11 and the decoding unit 12, and FLAN-XXL of Non-Patent Literature 1 may be employed for the encoding teacher unit 13 and the decoding teacher unit 14.

Parameters of FLAN may be employed as pre-learned parameters.

In the present embodiment, each of the encoding teacher unit 13 and the decoding teacher unit 14 uses a transformer encoder or decoder as with the encoding unit 11 and the decoding unit 12.

The loss calculation unit 15 calculates the following three types of losses (1) to (3), and sets a weighted sum of (1) to (3) as a loss function.
(1) A loss for generating a summary text. More specifically, negative log likelihood of a summary text generated on the basis of a score vector sequence with respect to a summary text given as a correct answer (that is, a negative value of a logarithm of a probability that a summary text given as a correct answer is generated on the basis of a score vector sequence). A cross-entropy loss is generally used as the loss, but any loss may be used.
(2) A loss for bringing a score vector sequence output from the decoding unit 12 close to a teacher score vector sequence output from the decoding teacher unit 14. An output KL-divergence loss or a mean square error of an internal state is generally used as the loss, but any loss may be used.
(3) A loss for bringing text features output from the encoding unit 11 close to teacher text features output from the encoding teacher unit 13. A mean square error is generally used as the loss, but any loss may be used.

Either (2) or (3), however, need not be added to a loss function value.

The parameter update unit 16 calculates a gradient of the loss function by a backpropagation method generally used in deep learning, and updates (learns) the parameters of the encoding unit 11 and the decoding unit 12.

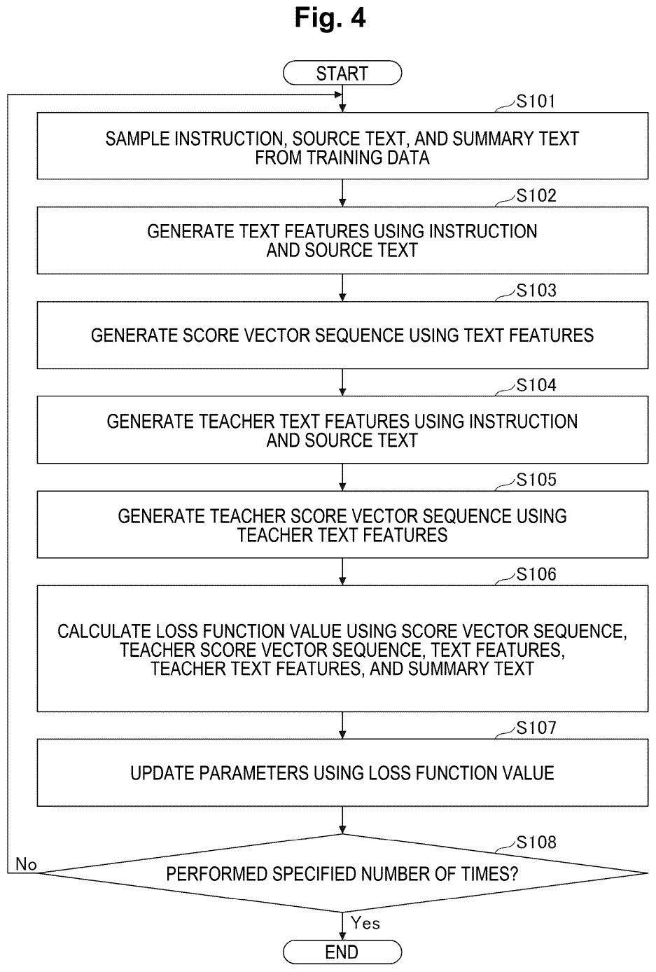

Processing procedures performed by the text generation apparatus 10 in FIG. 2 will be described hereinafter. FIG. 4 is a flowchart for describing an example of a first processing procedure of a process for learning the encoding unit 11 and the decoding unit 12 according to the first embodiment. In the case of performing knowledge distillation, the text generation apparatus 10 learns (the parameters of) the encoding unit 11 and the decoding unit 12 in the following processing procedure.

In step S101, the text generation apparatus 10 samples (selects) one set of an instruction, a source text, and a summary text from training data including a plurality of sets (of instructions, source texts, and summary texts). The selected set will be referred to as target data hereinafter. As the training data, a data set including many sets of instructions, source texts, and summary texts and created through crowdsourcing may be used.

Next, the encoding unit 11 generates text features using the instruction and the source text of the target data (by simultaneously receiving the instruction and the source text of the target data as inputs) on the basis of the parameters of the encoding unit 11 (S102).

Next, the decoding unit 12 generates a score vector sequence using the text features on the basis of the parameters of the decoding unit 12 (S103).

Next, the encoding teacher unit 13 generates teacher text features using the instruction and the source text of the target data (by simultaneously receiving the instruction and the source text of the target data as inputs) on the basis of the teacher parameters of the encoding teacher unit 13 (S104).

Next, the decoding teacher unit 14 generates a teacher score vector sequence using the teacher text features on the basis of the teacher parameters of the decoding teacher unit 14 (S105).

Next, the loss calculation unit 15 calculates a loss function value using the score vector sequence, the teacher score vector sequence, the text features, the teacher text features, and the summary text (S106).

Next, the parameter update unit 16 updates the parameters of the encoding unit 11 and the decoding unit 12 using the loss function value (S107).

When steps S101 to S107 are performed a specified number of times (Yes in S108), the processing procedure of FIG. 4 ends.

By using a knowledge distillation technique, the model size can be reduced. Furthermore, since the student model can obtain knowledge of the teacher model, the student model behaves similarly to the teacher model.

Note that the knowledge distillation need not necessarily be performed. Next, a case where knowledge distillation is not performed will be described.

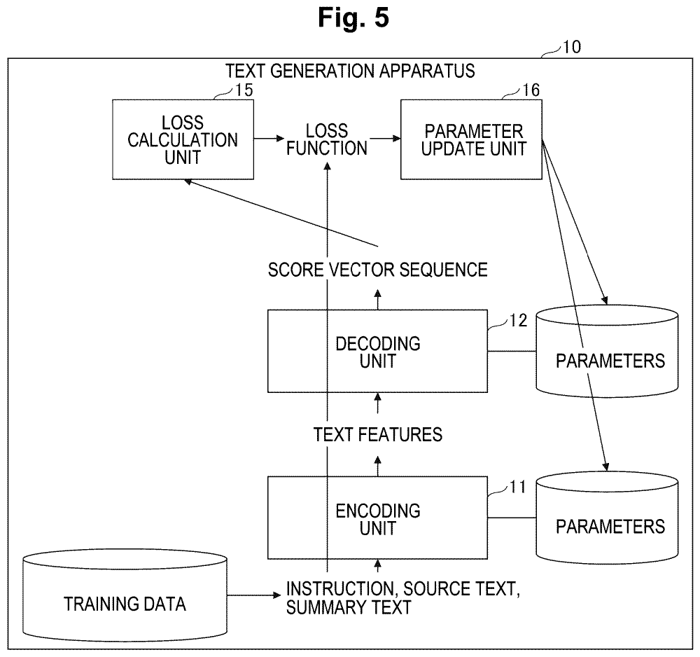

FIG. 5 is a diagram illustrating a second functional configuration example of the text generation apparatus 10 at the time of learning according to the embodiment of the present invention. FIG. 5 illustrates a functional configuration example of the text generation apparatus 10 in a case where knowledge distillation is not performed at the time of learning. In FIG. 5, the same or corresponding parts as those in FIG. 2 are given the same reference numerals, and description thereof is omitted as appropriate.

In a case where knowledge distillation is not performed, no teacher model is needed. In FIG. 5, therefore, the text generation apparatus 10 does not include the encoding teacher unit 13 and the decoding teacher unit 14, which are teacher models.

Furthermore, the loss calculation unit 15 calculates only the loss for generating a summary text.

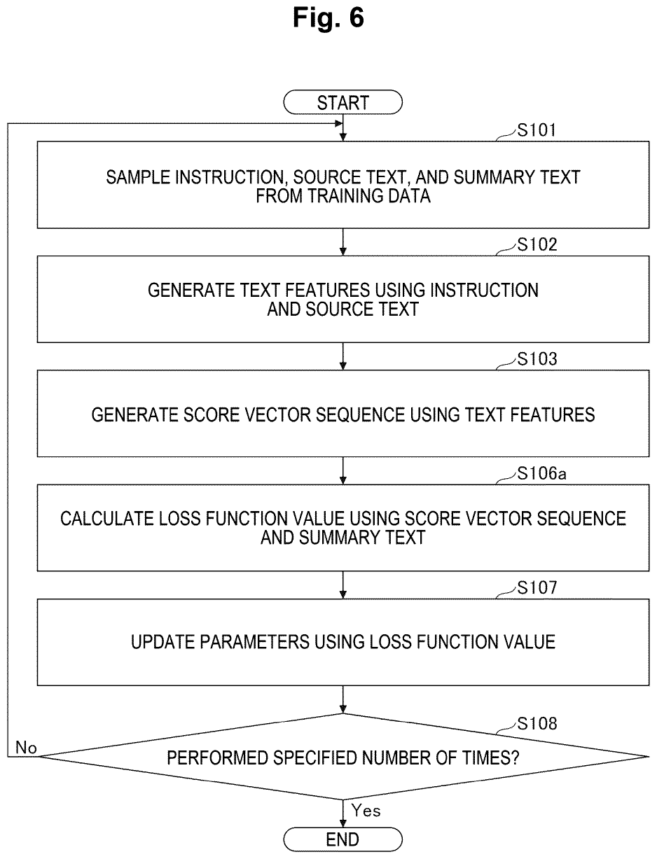

FIG. 6 is a flowchart for describing an example of a second processing procedure of a process for learning the encoding unit 11 and the decoding unit 12 according to the first embodiment. In FIG. 6, the same steps as those in FIG. 4 are given the same step numbers, and description thereof is omitted.

In FIG. 6, steps S104 and S105 for knowledge distillation are not performed. Furthermore, step S106 is replaced by step S106a.

In step S106a, the loss calculation unit 15 calculates a loss function value using the score vector sequence and the summary text.

Other steps are similar to those in FIG. 4.

### At Time of Inference

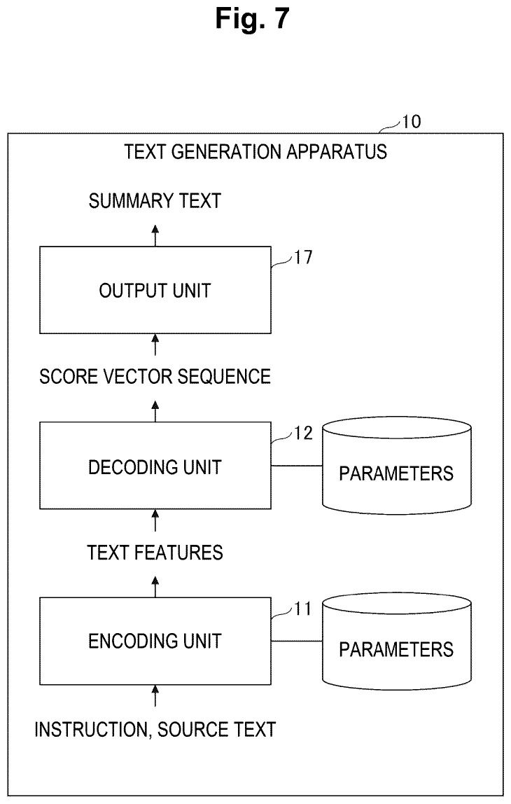

FIG. 7 is a diagram illustrating a functional configuration example of the text generation apparatus 10 at the time of inference according to the embodiment of the present invention. In FIG. 7, the same parts as those in FIG. 2 or FIG. 5 are given the same reference numerals, and description thereof is omitted.

As illustrated in FIG. 7, the text generation apparatus 10 at the time of inference includes the encoding unit 11, the decoding unit 12, and an output unit 17. Each of these units is achieved through processing performed by the processor 104 executing one or more programs installed in the text generation apparatus 10.

The encoding unit 11 and the decoding unit 12 are as described above. However, parameters of the encoding unit 11 and the decoding unit 12 have been learned through the processing procedure of FIG. 4 or FIG. 6.

The output unit 17 outputs a summary text such that a score of a score vector sequence, which is an output of the decoding unit 12, increases.

Note that the text generation apparatus 10 (text generation learning apparatus) at the time of learning and the text generation apparatus 10 at the time of inference may be achieved using different computers.

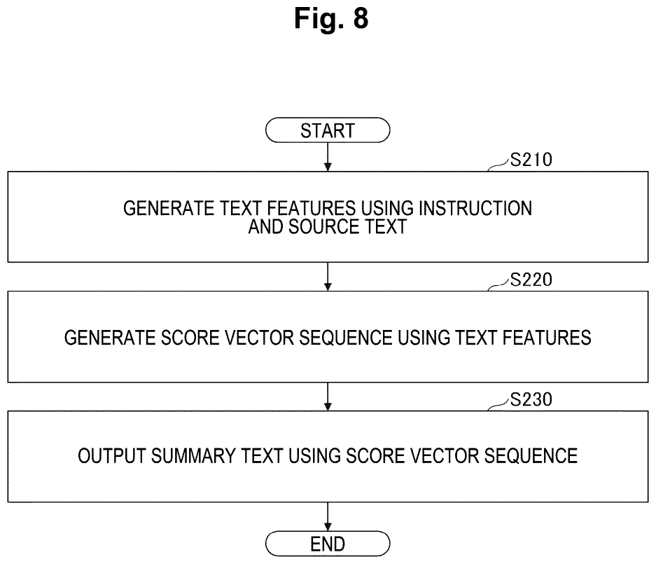

A processing procedure performed by the text generation apparatus 10 of FIG. 7 will be described hereinafter. FIG. 8 is a flowchart for describing an example of a processing procedure by the text generation apparatus 10 at the time of inference according to the first embodiment. The processing procedure of FIG. 8 is performed, for example, in response to an input of a summarization instruction (hereinafter simply referred to as an “instruction”) and a source text to be summarized (hereinafter simply referred to as a “source text”).

In step S210, the encoding unit 11 generates text features using the instruction and the source text on the basis of the learned parameters. At this time, as illustrated in FIG. 3, a self-attention matrix in which a sum of the number of tokens of the instruction and the number of tokens of the source text is set as the number of rows and the number of columns is used. Vectors of respective tokens of the instruction and the source text in a certain layer are vectors calculated in a previous layer.

Next, the decoding unit 12 generates a score vector sequence using the text features on the basis of the learned parameters (S220).

Next, the output unit 17 generates a text (token sequence) having the highest probability as a summary text on the basis of the score vector sequence and outputs the summary text (S230).

Next, a second embodiment will be described. In the second embodiment, differences from the first embodiment will be described. Points not specifically mentioned in the second embodiment may be similar to those in the first embodiment.

In the second embodiment, an example will be disclosed in which an instruction and a source text can be input at different timings. More specifically, an example will be disclosed in which an instruction is input first and a source text is allowed to be iteratively input. In doing so, a user can input an instruction only once and obtain summary texts for a plurality of different source texts with the same instruction.

### At Time of Learning

Either of the procedures of FIGS. 4 and 6 may be employed, but in either case, step S102 (the procedure for generating text features) is changed as follows.

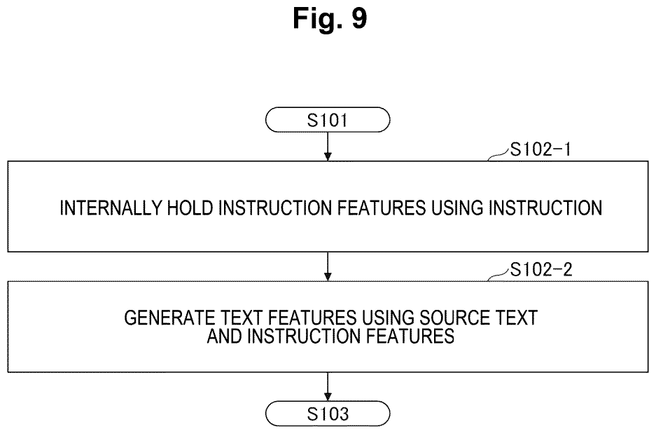

FIG. 9 is a flowchart for describing an example of a procedure for generating text features in a process for learning the encoding unit 11 and the decoding unit 12 according to the second embodiment. FIG. 9 illustrates that step S102 in FIG. 4 or 6 is divided into two steps, namely steps S102-1 and S102-2.

In step S102-1, the encoding unit 11 generates instruction features using an instruction of target data. The instruction features are text features related to the instruction. The instruction features, therefore, are a sequence of vectors for respective tokens of the instruction. A self-attention matrix used at this time is as follows.

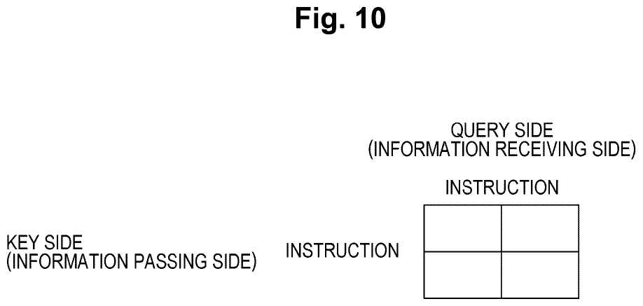

FIG. 10 is a diagram illustrating an example of a self-attention matrix in generating instruction features in the second embodiment. FIG. 10 illustrates a self-attention matrix in a case where the number of tokens constituting an instruction is 2. Note that, in the self-attention matrix, vectors corresponding to respective tokens constituting the instruction are vectors calculated in a previous layer.

In step S102-2, the encoding unit 11 generates text features using the instruction features generated in step S102-1 and a source text of the target data. More specifically, the encoding unit 11 generates the text features using the following self-attention matrix.

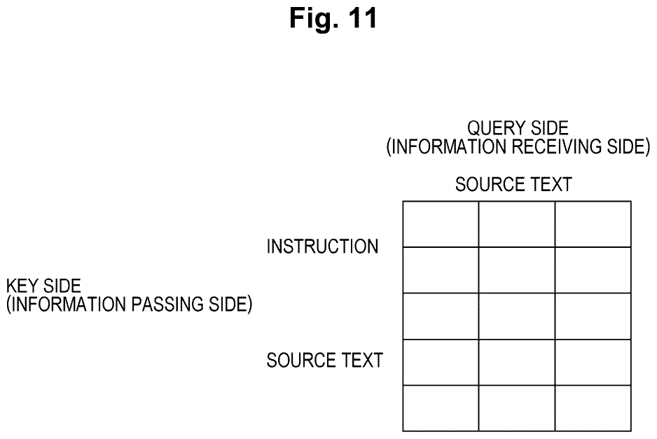

FIG. 11 is a diagram illustrating another example of the self-attention matrix in generating text features in the second embodiment. FIG. 11 illustrates a self-attention matrix in a case where an instruction includes two tokens and a source text includes three tokens. The self-attention matrix of FIG. 11 does not have columns corresponding to the instruction for a query side. Furthermore, in the self-attention matrix of FIG. 11, vectors corresponding to respective tokens constituting the instruction are vectors corresponding to respective tokens in the instruction features generated in step S102-1. Vectors corresponding to respective tokens constituting a source text, on the other hand, are vectors calculated in a previous layer.

As described above, in the second embodiment, encoding is performed for each instruction and each source text (encoding is performed twice in total) to generate text features.

At a time of learning, however, the encoding unit 11 may simultaneously receive an instruction and a source text as inputs and generate text features through single encoding. That is, step S102 need not be divided into S102-1 and S102-2. In this case, in step S102, the following self-attention matrix may be used.

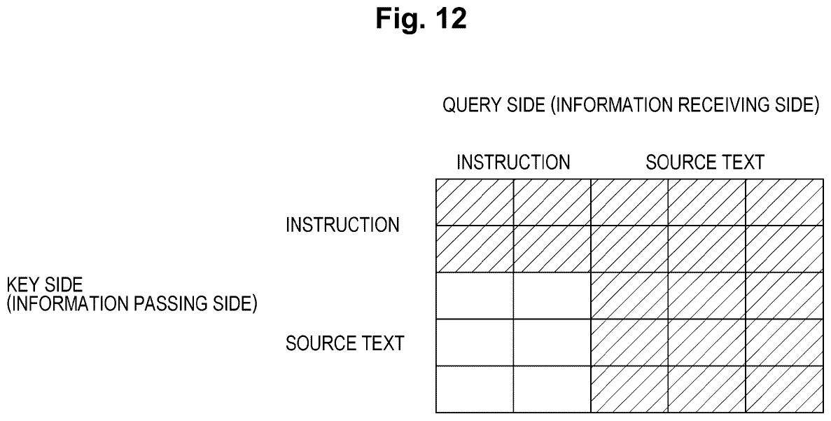

FIG. 12 is a diagram illustrating an example of a self-attention matrix in a case where an instruction and a source text are simultaneously input at a time of learning according to the second embodiment. In FIG. 12, the encoding unit 11 forcibly changes values of some components to 0, and therefore the components that become 0 and components that do not become 0 are expressed differently. That is, components whose backgrounds are white indicate the components whose values are 0. By changing the self-attention matrix in this way, the encoding of an instruction (generation of instruction features) can be performed only on the basis of the instruction, and the generation of text features can be performed using the instruction features and a source text. As a result, it is possible to generate, through single encoding, text features similar to those in the case where steps S102-1 and S102-2 are performed.

### At Time of Inference

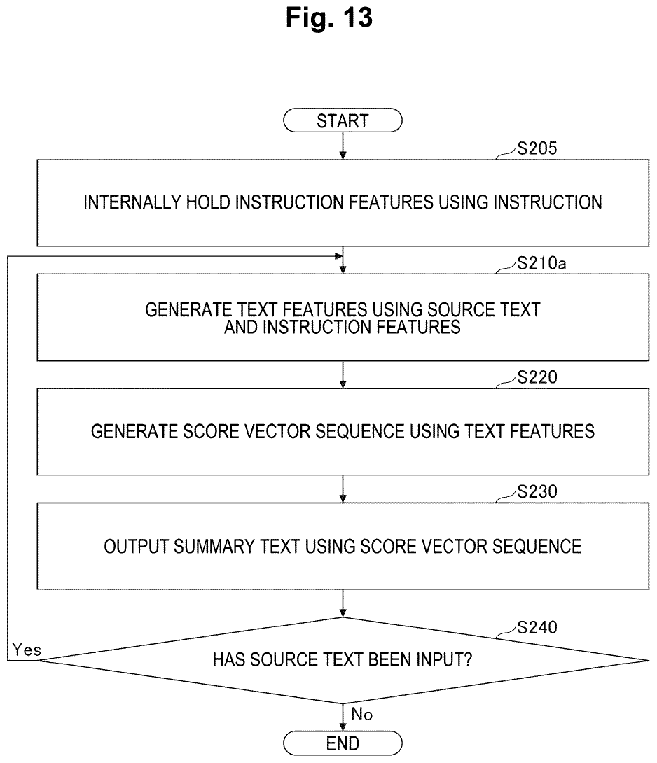

FIG. 13 is a flowchart for describing an example of a processing procedure by the text generation apparatus 10 at the time of inference according to the second embodiment. In FIG. 13, the same steps as those in FIG. 8 are given the same step numbers, and description thereof is omitted. In FIG. 13, steps S205 and S240 are added, and step S210 in FIG. 8 is replaced by S210a.

In step S205, the encoding unit 11 generates instruction features using an instruction on the basis of learned parameters and holds the instruction features therein (for example, stores the instruction features in the memory device 103). At this time, a self-attention matrix like the one illustrated in FIG. 10 is used.

Next, the encoding unit 11 generates text features using a source text and the instruction features held therein on the basis of the learned parameters (S210a). At this time, a self-attention matrix like the one illustrated in FIG. 11 is used.

Next, steps S220 and S230 are performed to generate a score vector sequence and output a summary text.

If the user newly inputs a source text because he/she wants to obtain summaries of different source texts for the same instruction (Yes in S240), for example, step S210a and subsequent steps are performed with the source text as a processing target. As a result, the user can obtain summary texts of different source texts for the same instruction.

Next, a third embodiment will be described. In the third embodiment, differences from the first or second embodiment will be described. Points not specifically mentioned in the third embodiment may be similar to those in the first or second embodiment.

In the third embodiment, an example will be disclosed in which a source text is input first and an instruction is allowed to be iteratively input. In doing so, the user can input a source text only once and obtain summary texts for a plurality of different instructions with the same source text.

### At Time of Learning

Either of the procedures of FIGS. 4 and 6 may be employed, but in either case, step S102 (the procedure for generating text features) is changed as follows.

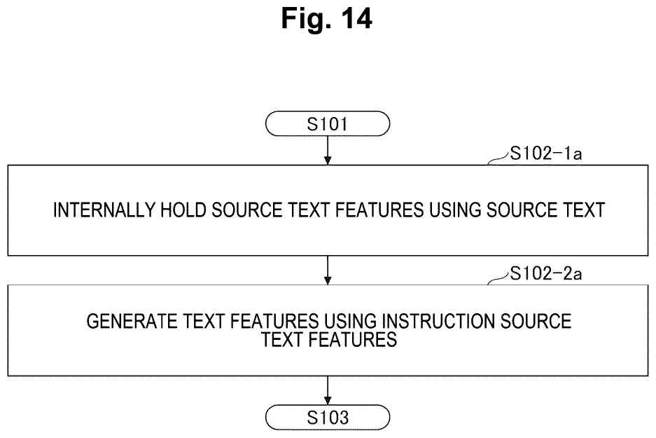

FIG. 14 is a flowchart for describing an example of a procedure for generating text features in a process for learning the encoding unit 11 and the decoding unit 12 according to the third embodiment. FIG. 14 illustrates that step S102 in FIG. 4 or 6 is divided into two steps, namely steps S102-1a and S102-2a.

In step S102-1a, the encoding unit 11 generates source text features using a source text of target data.

The source text features are text features related to the source text. The source text features, therefore, are a Sequence of vectors for respective tokens of the source text. A self-attention matrix used at this time is as follows.

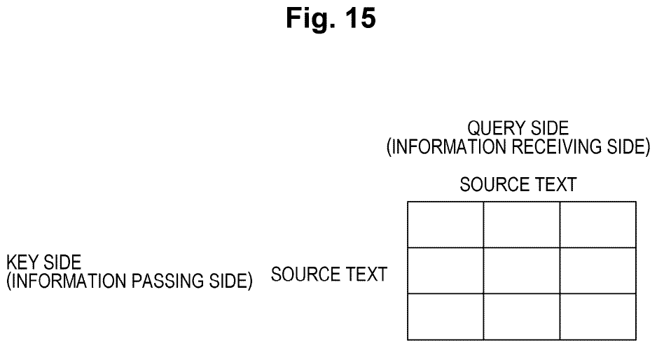

FIG. 15 is a diagram illustrating an example of a self-attention matrix in generating source text features in the third embodiment. FIG. 15 illustrates a self-attention matrix in a case where the number of tokens constituting a source text is 3. Note that, in the self-attention matrix, vectors corresponding to respective tokens constituting the source text are vectors calculated in a previous layer.

In step S102-2a, the encoding unit 11 generates text features using the source text features generated in step S102-1a and an instruction of the target data. More specifically, the encoding unit 11 generates the text features using the following self-attention matrix.

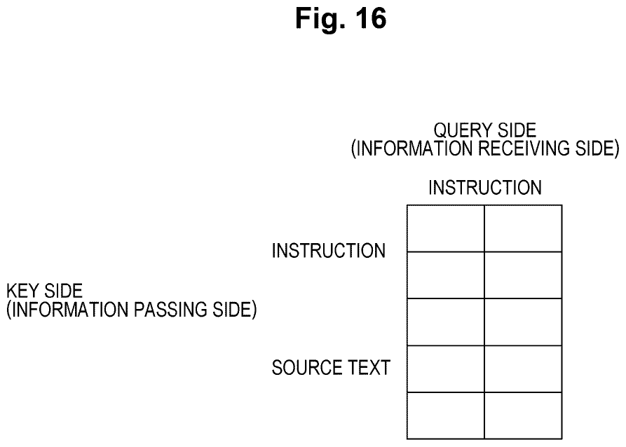

FIG. 16 is a diagram illustrating another example of the self-attention matrix in generating text features in the third embodiment. FIG. 16 illustrates a self-attention matrix in a case where an instruction includes two tokens and a source text includes three tokens. The self-attention matrix of FIG. 16 has no columns corresponding to the source text for the query side. Furthermore, in the self-attention matrix of FIG. 16, vectors corresponding to respective tokens constituting the source text are vectors corresponding to respective tokens in the source text features generated in step S102-1a. Vectors corresponding to respective tokens constituting the instruction, on the other hand, are vectors calculated in a previous layer.

As described above, in the third embodiment, encoding is performed for each source text and each instruction (encoding is performed twice in total) to generate text features.

At a time of learning, however, the encoding unit 11 may simultaneously receive an instruction and a source text as inputs and generate text features through single encoding. That is, step S102 need not be divided into S102-1a and S102-2a. In this case, in step S102, the following self-attention matrix may be used.

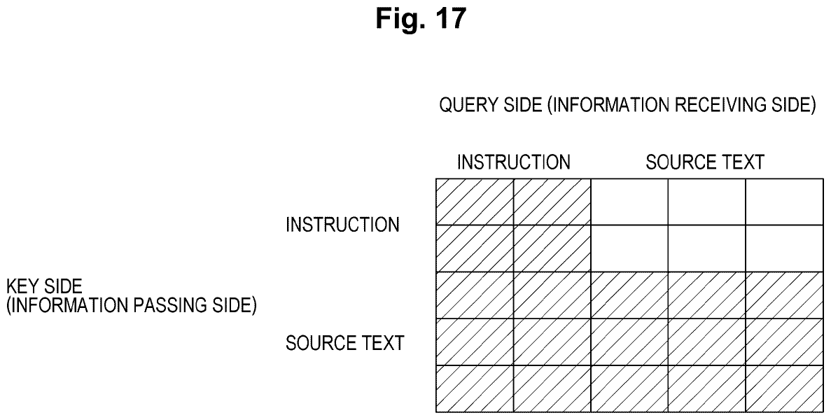

FIG. 17 is a diagram illustrating an example of a self-attention matrix in a case where an instruction and a source text are simultaneously input at a time of learning according to the third embodiment. In FIG. 17, the encoding unit 11 forcibly changes values of some components to 0, and therefore the components that become 0 and components that do not become 0 are expressed differently. That is, components whose backgrounds are white indicate the components whose values are 0. By changing the self-attention matrix in this way, the encoding of a source text (generation of source text features) can be performed only on the basis of the source text, and the generation of text features can be performed using the source text features and an instruction. As a result, it is possible to generate, through single encoding, text features similar to those in the case where steps S102-1a and S102-2a are performed.

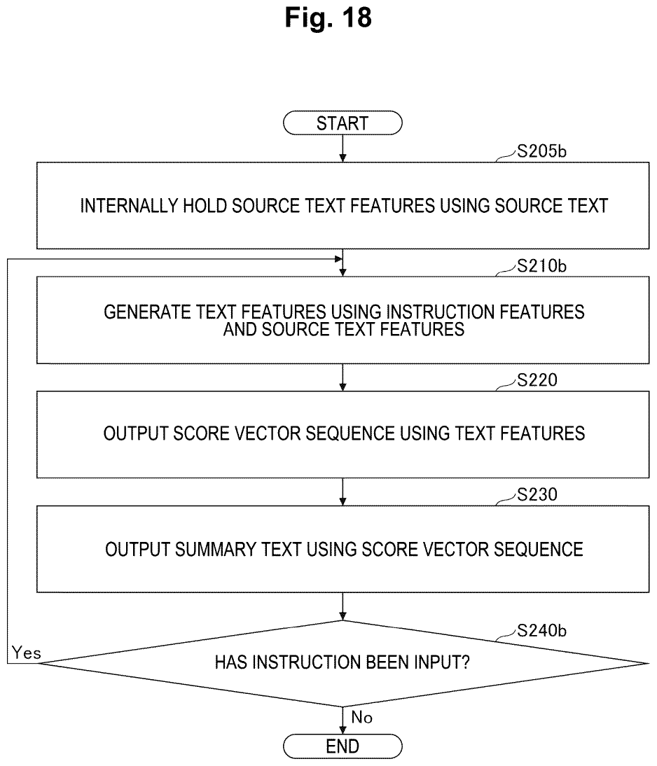

In the third embodiment, a processing procedure at the time of inference is different from that in FIG. 13. FIG. 18 is a flowchart for describing an example of a processing procedure by the text generation apparatus 10 at the time of inference according to the third embodiment. In FIG. 18, the same steps as those in FIG. 13 are given the same step numbers, and description thereof is omitted. In FIG. 18, steps S205, S210a, and S240 in FIG. 13 are replaced by S205b, S210b, and S240b, respectively.

In step S205b, the encoding unit 11 generates source text features using a source text on the basis of learned parameters and holds the source text features therein (for example, stores the source text features in the memory device 103). At this time, a self-attention matrix like the one illustrated in FIG. 15 is used.

In step S210b, the encoding unit 11 generates text features using an instruction and the source text features held therein on the basis of the learned parameters. At this time, a self-attention matrix like the one illustrated in FIG. 16 is used.

Steps S220 and S230 are performed similarly to those in FIG. 13, and a summary text is generated and output.

If the user newly inputs an instruction because he/she wants to obtain summaries of the same source text using different instructions (Yes in S240b), for example, step S210b and subsequent steps are performed with the instruction as a processing target. As a result, the user can obtain summary texts of the same source text for different instructions.

Note that two or more of the first to third embodiments may be combined together. In this case, at the time of learning, the learning processes according to the individual embodiments to be combined together may be mixed. For example, two or three learning processes may be performed for each set of an instruction, a source text, and a summary text of training data. Alternatively, the learning process of any one of the embodiments may be performed for each set of a source text and a summary text. At this time, a flag indicating an embodiment to which the learning process corresponds may be input into a language model (a language model including the encoding unit 11 and the decoding unit 12). At the time of inference, a flag indicating an embodiment to which inference to be performed corresponds may be input into the language model (a language model including the encoding unit 11 and the decoding unit 12). In doing so, the text generation apparatus 10 can be caused to perform a processing procedure of an embodiment corresponding to the flag.

As described above, according to the second or third embodiment, by including a mechanism for encoding only one of an instruction and a source text and holding the encoded one therein in a summarization task according to the instruction, it is possible to omit recalculation (iterative calculation) for encoding of the one in a case where only the other is iteratively given. Calculation efficiency regarding summarization according to the instruction, therefore, can be improved.

Furthermore, in a case where only one of an instruction and a source text is first encoded after training using knowledge distillation, it is possible to generate a high-performance summary text even with a reduced model size. A summary, therefore, can be generated at high speed and high performance even in a use case of an actual service.

Note that, in a case where knowledge distillation is performed in the second and third embodiments, since a model that takes into consideration an interaction of all tokens in self-attention is used as a teacher, the encoding unit 11 and the decoding unit 12 can behave in such a way as to compensate for a fact that the encoding unit 11 cannot take into consideration the interaction.

### Reference Literatures

Reference Literature 1: Geoffrey Hinton, et al., “Distilling the knowledge in a neural network”, [online], Internet <URL:https://arxiv.org/abs/1503.02531>
Reference Literature 2: Ashish Vaswani, et al., “Attention Is All You Need”, [online], Internet <URL:https://arxiv.org/abs/1706.03762>

Although embodiments of the present invention have been described in detail above, the present invention is not limited to such specific embodiments, and various modifications and changes can be made within the scope of the gist of the present invention disclosed in the claims.

### REFERENCE SIGNS LIST

10 Text generation apparatus
11 Encoding unit
12 Decoding unit
13 Encoding teacher unit
14 Decoding teacher unit
15 Loss calculation unit
16 Parameter update unit
17 Output unit
100 Drive device
101 Storage medium
102 Auxiliary storage device
103 Memory device
104 Processor
105 Interface device
B Bus

1. A text generation learning method performed by a computer, the text generation learning method comprising:
receiving, as inputs, a source text and an instruction related to a summary of the source text, generating, by using an encoding parameter, first features, which are a sequence of vectors for respective tokens constituting one of the instruction and the source text, and generating, by using the encoding parameter, text features, which are a sequence of vectors for respective tokens of the instruction and the source text, based on another of the instruction and the source text and the first features;
receiving the text features as an input and outputting probability distribution of a text by using a decoding parameter; and
updating the encoding and decoding parameters based on a loss between the probability distribution and a text as a correct answer regarding the summary.

2. A text generation method performed by a computer, the text generation method comprising:
receiving, as inputs, a first source text and an instruction related to a summary of the first source text, generating instruction features, which are a sequence of vectors for respective tokens constituting the instruction, and generating first text features, which are a sequence of vectors for respective tokens of the instruction and the first source text, based on the first source text and the instruction features;
receiving the first text features as an input and outputting first probability distribution of a text;
outputting a first text based on the first probability distribution;
generating, in response to receiving a second source text as an input, second text features, which are a sequence of vectors for respective tokens of the instruction and the second source text, based on the second source text and the instruction features;
receiving the second text features as an input and outputting second probability distribution of a text; and
outputting a second text based on the second probability distribution.

3. A text generation method performed by a computer, the text generation method comprising:
receiving, as inputs, a source text and a first instruction related to a summary of the source text, generating source text features, which are a sequence of vectors for respective tokens constituting the source text, and generating first text features, which are a sequence of vectors for respective tokens of the first instruction and the source text, based on the first instruction and the source text features;
receiving the first text features as an input and outputting first probability distribution of a text;
outputting a first text based on the first probability distribution;
generating, in response to receiving a second instruction as an input, second text features, which are a sequence of vectors for respective tokens of the second instruction and the source text, based on the second instruction and the source text features;
receiving the second text features as an input and outputting second probability distribution of a text; and
outputting a second text based on the second probability distribution.

4. (canceled)

5. (canceled)

6. (canceled)

7. A non-transitory computer-readable recording medium having computer-readable instructions stored thereon, which when executed, cause a computer to perform the text generation learning method of claim 1.

8. A non-transitory computer-readable recording medium having computer-readable instructions stored thereon, which when executed, cause a computer to perform the text generation method of claim 2.

9. A non-transitory computer-readable recording medium having computer-readable instructions stored thereon, which when executed, cause a computer to perform the text generation method of claim 3.
